(19) United States
(12) Patent Application Publication
(10) Pub. No.: US 2011/0242295 A1
(43) Pub. Date: Oct. 6, 2011

(54) Three dimension image display method

(76) Inventor: Joe Yue, Plano, TX (US)

(21) Appl. No.: 12/662,096

(22) Filed: Mar. 31, 2010

(51) Int. Cl. H04N 13/04

(52) U.S. Cl. 348/54

(57) ABSTRACT

Disclosed is a three dimensional image display method and some application structures. The three dimensional display method employs one piece of flat mirror to separate an observer's right and left eyes while flipping one image, either right or left, to overlay with another to render a vivid three dimensional image. The method does not need eyeglasses, does not need to see through any optical elements, has no limit to the field of view, and is the most nature method for observers to view a three dimensional image just as to view the real world with naked eyes.

### BACKGROUND OF THE INVENTION

1. Field of the Invention

The present invention generally relates to a stereo image display method, and more particularly, to a method capable of displaying a stereo image of a type which does not require the use of stereo viewing spectacles or any other kinds of optical elements, but gives the highest quality three dimensional effect with most natural observation way and lowest cost as oppose to current 3D image display methods.

2. Description of the Prior Art

Three dimensional photograph, or in other words, to record and display the three dimensional world with high quality and convenient equipment has been a long time dream for decades. Holographic technology and stereo imaging technology are the major technologies that have been developed for this purpose. Holographic technology can record every angle of an object and display the original object with lossless information. Unfortunately, because of the sophisticate demands on recording and display conditions, hologram has only limited applications so far. On the other hand, stereo imaging method record only two adjacent images of an object from one particular angle and then display the two images to an observer's left and right eyes respectively to reproduce a vivid three dimensional image of the original object in one particular angle. This method is gaining more and more applications because it can achieve a vivid three dimensional display without sacrificing the high quality of a traditional two dimensional color picture.

The easiest way to observe a stereo image is to arrange the two images side by side and viewers can intentionally focus two eyes to the two images either parallelly or crossingly. The problem with this easy-to-use method is that the viewers' eyes have to be trained to be able to focus to some empty spot with intension, which is not natural to observers.

Another method to observe a stereo image is to use a stereoscope or any other binocular or head mount type of optical system to display two images to left and right eyes respectively. The expensive, bulky stereoscope system has limited field-of-view, hence is mainly used in laboratory. The head mounted system also has limited field-of-view, and is inconvenient for general users, so they are mainly used for training systems.

The third method to observe a stereo image is to use eyeglasses, such as passive filters like color filters or polarizes, or active eyeglass shutters, to direct the left and right images to the observer's left or right eye respectively. The passive polarizer eyeglass method has been successfully used in three dimensional theaters, and it is expected that most of the theaters will be in this type of three dimensional format in the near future. The active eyeglass shutter method is mainly used for three dimensional TV. The major drawback of all these eyeglass based applications is the inconvenience of eyeglasses. Besides, the images have to be color coded or the sources have to be maintained as polarized light.

The fourth method to observer a stereo image is to use a Lenticular sheet aligned in front of the interlaced images. The lenticular lens can direct the left and right images to the observer's corresponding eyes. This method sacrificed the picture quality with the interlacing process and the lenticular lens abbreviations. It also renders an unnatural image view to observers because of the fact that viewers are observing “diffracted images through the lenticular lens” other than directly reflected images as human eyes are used to.

With three dimensional digital camera coming available and more and more three dimensional videos become available, there is a need to have a three dimensional display method which should be able to display three dimensional images as high quality as traditional two dimensional color pictures, it should be convenient, no eyeglasses needed, no intentional focus training needed, no limit on field of view, not seeing through any optical element or systems, it should be cost effective and fit for public applications. This is what this invention addresses.

### SUMMARY OF THE INVENTION

This invention is a low-cost easy-to-use stereo image display method to let an observer to view stereo images in the most natural way just as viewing the actual world with naked eyes. The invented stereo image display method employs a regular flat mirror to overlay the left or the right stereo image to another, so that the observer's left and right eyes can only observe the corresponding images in a natural observation way. This stereo image display method renders the best three dimensional effects because it does not require any spectaculars or any other optical systems, it does not require intentional eye focus training, observers see the three dimensional image by viewing regular high quality two dimensional color pictures with naked eyes.

### BRIEF DESCRIPTION OF THE DRAWINGS

FIG. 1. Shows one embodiment of the three dimensional image display method, which utilize a flat mirror to reflect the left image to overlay to the right image. The left image, which is the horizontally flipped image of the original left image, is herein the reference image.

FIG. 2. Shows another embodiment of the three dimensional image display method, which utilize a flat mirror to reflect the right image to overlay to the left image.

FIG. 3. shows another embodiment of the three dimensional image display method, which utilize two flat mirrors to reflect both left and right images and overlay them in the middle. Both images are horizontally flipped.

FIG. 4. shows one embodiment of the three dimensional image display method. The left and right images are assembled like a book. The flat mirror is used to reflect the left images to overlay to the right images.

FIG. 5. shows another embodiment of the three dimensional image display method. The left and right images are assembled like a book. The flat mirror is used to reflect the right images to overlay to the left images.

FIG. 6. shows another embodiment of the three dimensional image display method. The left and right images are assembled like a book. Two flat mirrors are used to reflect both left and right images and overlap them in the middle.

FIG. 7. shows one embodiment of the three dimensional image display method. The left and right images are displayed on any display devices such as computer monitors, TV monitors, digital picture frames, digital book reader, gaming device screens, or cell phone screens. A flat mirror is used to reflect the left display device to overlay to the right display device.

FIG. 8. shows one embodiment of the three dimensional image display method. The left and right image display devices are the same as that in FIG. 7. A flat mirror is used to reflect the right display device to overlay to the left display device.

FIG. 9. shows another embodiment of the three dimensional image display method. The left and right image display devices are the same as that in FIG. 7. Two flat mirrors are used to reflect both left and right display devices and overlap them in the middle.

### DETAILED DESCRIPTION OF THE INVENTION

The three dimensional display method invented here is using a flat mirror to flip one of the two stereo images, left or right, to overlay with another, so the observer's left and right eyes will see the overlapped left and right images respectively, and hence will perceive a vivid three dimensional image of the original object just as viewing the actual object. This three dimensional display method does not need eyeglasses, does not need intentional eye focus training, does not need to see through any optical elements or systems, has no limit to field of view, it renders the best three dimensional effect without sacrificing the high quality of the images. This convenient method is also cost effective and suitable for various public applications, such as 3D books, 3D exhibitions, 3D monitors, just to name a few.

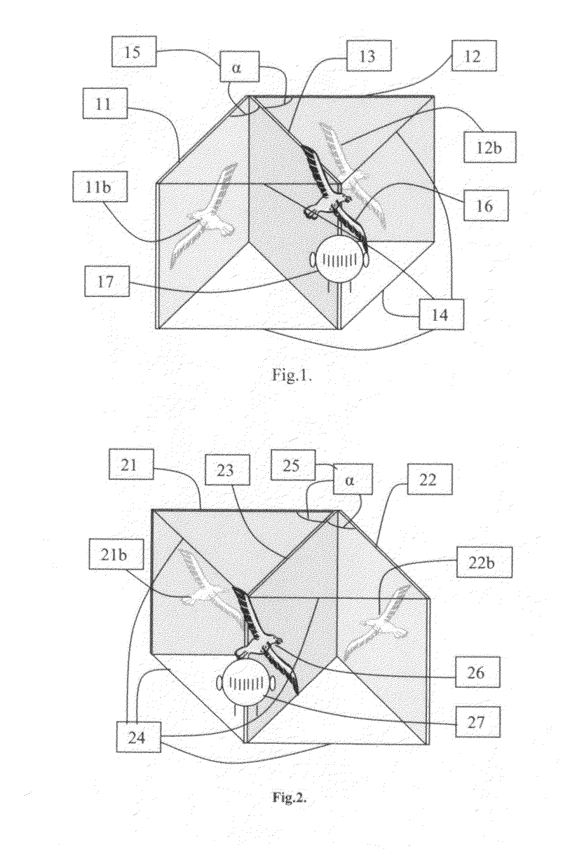

FIG. 1 shows one embodiment of a three dimensional exhibition display. A flat mirror 13 is inserted between two display boards 11 and 12. The angle between the mirror and the two display boards is α (15), which is around 60 degrees. Wires 14 are used to fix these angles around 60 degrees. Other fixtures such as corner guard can be used to fix these angles in stead of wires. Display board 11 holds the horizontally flipped image of the original left image 11b as a reference image, display board 12 hold the original right image 12b. The flat mirror 13 reflect the image 11b to overlap with the right image 12b, so the observer's (17) left eye will only see the mirrored image of 11b, while right eye will only see the right image 12. This parallax renders a vivid three dimensional image 16 to the observer 17.

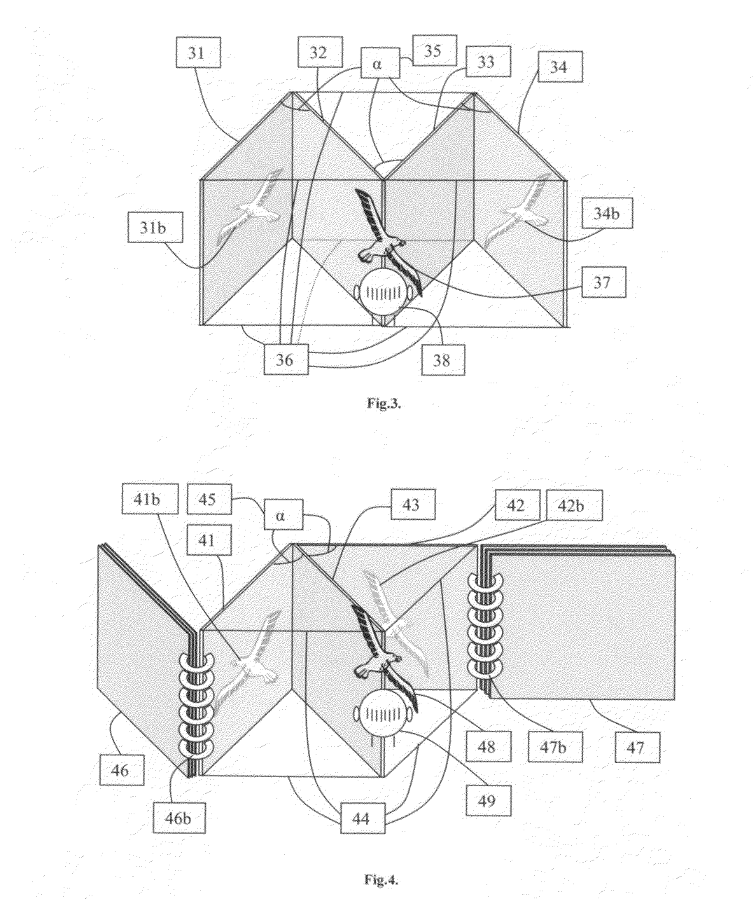

FIG. 2 shows another embodiment of a three dimensional exhibition display. The structure is similar to FIG. 1, except that the mirror 23 is on the right side, and the image 22b is the reference image, which is the horizontally flipped image of the original right image, while the left image 21b is the original left image. The observer (27)'s left eye will only see the original left image 21b, while right eye will only see the mirror reflected image of the reference image 22b, this parallax renders a vivid three dimensional image 26 to observer 27.

Although it is not illustrated here, but the mirror of both FIG. 1 and FIG. 2 can be a double sides mirror instead of a single side mirror. In this case, if the observer is facing the left side image, the right side image will be the reference image, and this will be the same case as illustrated in FIG. l. While if the observer is facing the right side image, the left side image will be the reference image, and this will be the same case as that illustrated in FIG. 2, except that the observed three dimensional image is the mirror image as that of when the observer facing the left image.

FIG. 3 shows another embodiment of the three dimensional exhibition display. In this embodiment, two pieces of flat mirror is assembled with the left side display board and right side display board with angle α (35), which is around 60 degree. Both the left image 31b and the right image 34b are reference images and they are the horizontally flipped images of the original left and right images. The two mirrors reflect the two reference images and overlap them in front of the observer 38, so the observer's left eye will see only the reflected left reference image 31b, and the observer's right eye will only see the reflected right reference image 34b, this parallax then renders the high quality three dimensional image 37 to the observer. All the wires 36 are used to fix the angles α at about 60 degrees. Other fixtures such as 60 degree corner guard can also be used to fix the angle α and replace the wires 36.

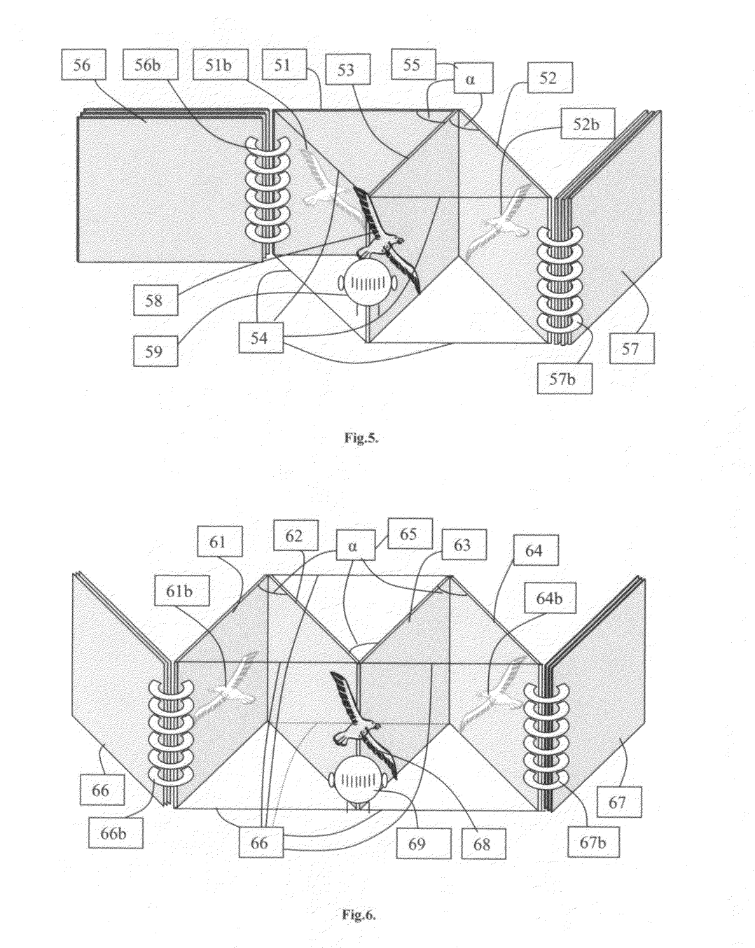

FIG. 4 shows one embodiment of the three dimensional book. The three dimensional structure is similar to that of FIG. 1, where a left side mirror is used. The main difference is that FIG. 4 shows the structure that assembled like a book, which can be used but not restricted to picture books, photo albums, product menus, etc. Book pages or photo pockets 46 hold the horizontally flipped left images as reference images. It is bound with 41 using wire 46b. While pages or photo pockets 47 hold the corresponding right images, and is bound with 42 using wire 47b. Pages 46 and 47 can also be wire bound on the top or the bottom. It is obvious that pages 46 and 47 have to be flipped correspondingly to have the same left and right image pairs at the same time. Wires 44 are used to fix the angle α (45) around 60 degrees. Again, other kinds of 60 degree corner guard can be used to replace the wires.

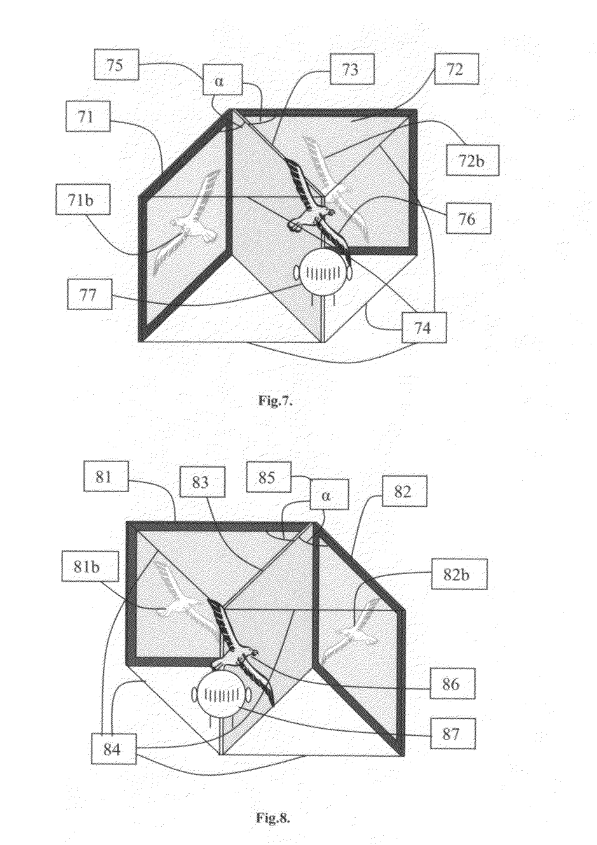

FIG. 5 shows another embodiment of the three dimensional book. The three dimensional structure is similar to that of FIG. 2, where a right side mirror is used. Again, the main difference is that FIG. 5 shows the structure that assembled as a book. Book pages or photo pockets 57 hold the horizontally flipped right images as reference images. It is bound with 52 using wire 57b. While pages or photo pockets 56 hold the corresponding left images, and is bound with 51 using wire 56b. FIG. 6 shows another embodiment of the three dimensional book. The three dimensional display structure is similar to that of FIG. 3, except that here it is assembled as a book.

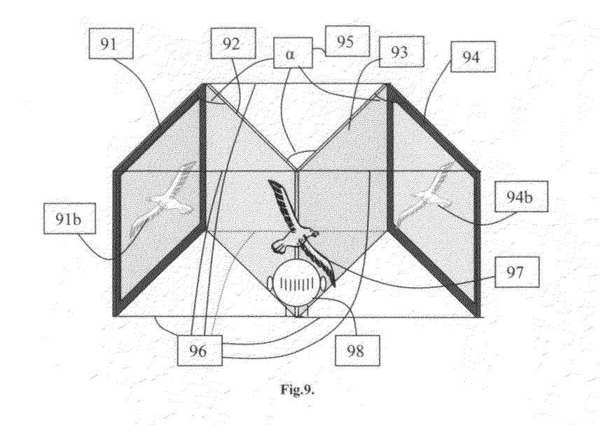

FIG. 7 shows one embodiment of the three dimensional display unit. The structure is similar with that in FIG. 1, except that the display devices 71 and 72 are computer monitors, digital picture frames, digital book readers, TV monitors, gaming device screen, cellular phone screen, or any other electrical display devices, etc. FIG. 8 shows another embodiment of the three dimensional display unit. The structure is similar with that in FIG. 2. The display devices 81 and 82 are the same as 71 and 72 in FIG. 7. The mirrors in FIG. 7 and FIG. 8 can be double sided mirror instead of single side. The wires 74 and 84 can also be replaced with other fixtures such as 60 degree corner guard, or just arrange the display devices and the mirrors at the fixed 60 degree angle. FIG. 9 shows yet another embodiment of the three dimensional display unit. The display structure is similar as that in FIG. 3. The display devices 91 and 94 are the same as 71 and 72 in FIG. 7. Wires 96 can also be replaced with any other fixtures to fix the angle α (95) around 60 degrees.

It is noticed that all the illustrated display structures are having the mirrors and the image boards or display devices connected together. But this is not a necessary condition, in other words, the mirrors and the image boards or the display devices can be arranged separately, if only that the perceived images are overlapped together in front of the observer with parallax, then the observer can see the vivid three dimensional image.

It is also noticed that viewers have the flexibility to choose to view three dimensional or two dimensional images easily. This is especially convenient to design engineers. And moreover, by adjusting the parallax, or the horizontal relative positions of the left and right display units, or the image positions on the display units, the depths of the three dimensional image can be adjusted.

While these particular embodiments have been described in this disclosure, alternative embodiments are possible. Furthermore, it is noticed that although the disclosed imaging systems are described as being integrated into “books, exhibition displays, computer monitors, etc.” it is to be understood that it is not intended to limit the applications of the imaging systems to these applications. Instead, applicant is generally referring to apparatus that can use regular mirror or mirrors to reflect one or both of the left and right images to overlap together to form the parallax to render a three dimensional image, regardless of the particular configuration of the apparatus or applications.

What is claimed is:

1. A three dimensional image display method comprising:
a single mirror; and
a left side image display unit to display the left image; and
a right side image display unit to display the right image; and
some angle-fixing fixtures to set the angle between the mirror and the display units about 60 degrees.

2. The three dimensional image display method of claim 1, wherein the “left image” and the “right image” are referring the left and right images that are taken by either a stereo camera or two synchronized cameras side by side, or computer designed left and right stereo images, graphics, or engineering drawings. The “left display unit” and the “right display unit” are the display units that display the “left image” or the “right image” respectively. The “left mirror” or the “right mirror” are the mirrors that reflect the “left image” or the “right image” respectively.

3. The three dimensional image display method of claim 1, wherein the mirror is a single left side mirror, or a single right side mirror, or a double sided mirror, which is used to reflect the left image or the right image to overlap to the other to form parallax to the observer.

4. The three dimensional image display method of claim 1, wherein the left side display unit and the right side display unit are any kind of image or picture display structures or devices, such as display boards or frames, assembled picture books, assembled album with photo pockets, or computer monitors, TV monitors, digital photo frames, digital book readers, gaming device screens, cell phone screens.

5. The three dimensional image display method of claim 1, wherein, the left side display unit, the right side display unit, and the mirror in the middle, they are integrated together with around 60 degree angles between them, or they are arranged separately with a relative angle of around 60 degree.

6. The three dimensional image display method of claim 1, wherein the angle-fixing fixtures are any ways that can fix the angles of around 60 degree, such as wires, ribbons, corner guards, or frames, etc.

7. The three dimensional image display method of claim 1, wherein the depth of the observed three dimensional image can be adjusted through adjusting the parallax, or the horizontal relative positions of the left image and the right image on the left and right display units, or the horizontal relative positions of the left and right display units.

8. The three dimensional image display method of claim 1, wherein if the mirror is used as a left mirror, then the left side display unit should display the horizontally flipped image, if the mirror is used as a right mirror, then the right display unit should display the horizontally flipped image, if the mirror is a double sided mirror, then either the left or the right side display unit should display the horizontally flipped image. And the observed three dimensional image in one case is the mirror image of the other.

9. A three dimensional image display method comprising:
two mirrors; and
a left side image display unit; and
a right side image display unit; and
some angle-fixing fixtures to fix the angles between the two mirrors and that between the mirrors and the display units about 60 degree.

10. The three dimensional image display method of claim 9, wherein the left side display unit and the right side display unit are any kind of image or picture display structures or devices, such as display boards or frames, assembled picture books, assembled album with photo pockets, or computer monitors, TV monitors, digital photo frames, digital book readers, gaming device screens, cell phone screens, etc.

11. The three dimensional image display method of claim 9, wherein, the left side display unit, the right side display unit, and the two mirrors in the middle, they are integrated together with around 60 degree angles between them, or they are arranged separately with a relative angle of around 60 degree.

12. The three dimensional image display method of claim 9, wherein the left flat mirror reflect the left image and the right flat mirror reflect the right image, and both reflected images are overlapped in the middle and forms the parallax to the observer.

13. The three dimensional image display method of claim 9, wherein both the left and right display units should display the horizontally flipped images to render a three dimensional image of the original object. Or they can both display the original left and right images to render a horizontally flipped three dimensional image of the original object.

14. The three dimensional image display method of claim 9, wherein the depth of the observed three dimensional image can be adjusted through the adjustment of the relative horizontal positions of the display units or the image positions on the display units.

15. The three dimensional image display method of claim 9, wherein the angle-fixing fixtures are any ways that can fix the angles of around 60 degree, such as wires, ribbons, corner guards, or frames.
